(19) United States
(12) Patent Application Publication
(10) Pub. No.: US 2017/0028534 A1
(43) Pub. Date: Feb. 2, 2017

(54) FISHING PLIERS

(71) Applicant: Wenhan GENG, Dalian (CN)

(72) Inventor: Wenhan GENG, Dalian (CN)

(21) Appl. No.: 14/848,594

(22) Filed: Sep. 9, 2015

(30) Foreign Application Priority Data
Jul. 31, 2015 (CN) 201510460942.2

(51) Int. Cl. B25B 7/12

(52) U.S. Cl. CPC B25B 7/123

(57) ABSTRACT

A fishing pliers comprising a upper clamping member having a first gear fixed after the front end of the upper clamping member; a lower clamping member having protrusion extending upwardly, to form a jaw opening for holding fish mouth with the protrusion extending downwardly positioned at the front end of the upper clamping member and a second gear fixed after the front end of the lower clamping member, which is engaged with the first gear; an upper handle, the upper clamping member pivoting to the front end of the upper handle through the drive shaft of the first gear, and the lower clamping member pivoting to the front end of the upper handle by the drive shaft of the second gear; and an lower handle, the lower clamping member pivoting to the front end of the lower handle at a first pivot point of the back end of the lower clamping member; herein, the lower handle moves with respect to the upper handle, to drive the second gear of the lower clamping member rotating with respect to the first gear of the upper champing member relatively, and to implement contact or separation between the front end of the upper clamping member and the front end of the lower clamping member. The fishing pliers disclosed in the present invention is comfortable and convenience, and allows the upper clamping member and the lower clamping member to reach a appropriate opening angle.

### CROSS-REFERENCE TO RELATED APPLICATION

This application claims the priority benefit of Chinese patent application No. 201510460942.2, filed Jul. 31, 2014. The entirety of the above-mentioned patent application is hereby incorporated by reference herein and made a part of specification.

### FIELD OF THE INVENTION

The invention relates to a device for catching fish and unloading fish, more particularly to a fishing pliers.

### BACKGROUND ART

Many types of pliers known in the art can grip fish lips, and fishermen can use those pliers to grip fish which has been fished unload them. The current fishing pliers can achieve the intended purpose substantially, but they still need to improve in some fields.

In the prior art, fishing pliers is composed of upper clamping member, lower clamping member, upper handle and lower handle. The upper handle is fixed to the upper clamping member and the lower handle is rotatably connected to the lower clamping member. When the lower handle moves towards the upper handle, the lower clamping member driven by lower clamping member pivots close to or away from the upper clamping member so as to make the pliers open or close. In this time, the opening angle between the lower clamping member and the upper clamping member is the same as the opening angle between the lower handle and the upper handle. Firstly, a problem is increased that is: in order to make the opening angle between the lower clamping member and the upper clamping member large enough (only if the opening angle is large enough, the jaw opening is able to clamp fish lips), the lower handle must also be able to open a large angle. But if the opening angle of the lower handle is too large, the difficulty of gripping the handle is increased, so the convenience of operation is distroyed. Secondly, the above existing pliers also result in the opening speed of the lower clamping member being slowly. Thirdly, since the upper clamping member is fixed to the upper handle, that is the upper clamping member could not move for opening, but only the lower clamping member can move for opening, the opening angle between the lower clamping member and the upper clamping member is not large enough.

### SUMMARY

For the above-mentioned technical problem, the present invention provides a fishing pliers of which the opening angle between the lower clamping member and the upper clamping is appropriate, and the fishing pliers are easy to use.

A fishing pliers comprising:

an upper clamping member of having a protrusion extending downwardly at it's front end and a first gear fixed after the front end;

a lower clamping member protrusion extending upwardly at it's front end to form a jaw opening for holding fish mouth with the protrusion extending downwardly positioned at the front end of the upper clamping member, and having a second gear fixed after the front end of the lower clamping member, which is engaged with the first gear;

an upper handle, the upper clamping member pivoting to the front end of the upper handle through the drive shaft of the first gear, and the lower clamping member pivoting to the front end of the upper handle through the drive shaft of the second gear;

and a lower handle, the lower clamping member pivoting to the front end of the lower handle at a first pivot point of the back end of the lower clamping member;

Wherein, the lower handle moves with respect to the upper handle, to drive the second gear of the lower clamping member rotating with respect to the first gear of the upper champing member relatively, and to implement contact or separation between the front end of the upper clamping member and the front end of the lower clamping member.

Preferably, about the fishing pliers, a tongue and a groove cooperating with each other are provided on two relative laterals of the upper clamping member and the lower clamping member respectively, to make the tongue insert into the groove in the case of the front end of the upper clamping member and the front end of the lower clamping member contacting with each other.

Preferably, the fishing pliers further comprising:

connecting rod, whose first end pivoting to a second pivot point of the upper handle, and second end pivoting to a third pivot point of the lower handle, moreover the pivoting position between the upper handle and the lower handle is configured to: when the lower handle moves closely to the upper handle, to make the front end of the upper clamping member and the front end of the lower clamping member contacting with each other, the third pivot point is located above a line obtained by connecting the first pivot and the second pivot.

Preferably, about to the fishing pliers, the connecting rod having a stopper protruding outwardly at one end thereof near the lower handle, and the protruding length of the stopper is configured to: as the lower handle moves closely to the upper handle gradually, the third pivot point will gradually move from below to above a line obtained by connecting the first pivot and the second pivot. When the third pivot point reaches a predetermined height, the stopper contacting against the lower handle to make the lower handle could not further close to the upper handle;

Wherein the predetermined height is determined by when the front end of the upper clamping member and the lower clamping member contacts with each other, the contact force between the front end of the upper clamping member and the lower clamping member achieves a predetermined value.

Preferably, about to the fishing pliers, the lower handle moving to a place far away from the upper handle to make the front end of the upper clamping member and the front end of the lower clamping member contacting with each other, a part of the upper clamping member that is after the first gear interferes with a part of the lower clamping member that is after the second gear.

Preferably, about to the fishing pliers, the third pivot point is located at a position closed to the inner side of the lower handle; The lower handle has a hollow interior space, and the stopper being located into the interior space and contacts against the outer lateral wall of the lower handle.

Preferably, the fishing pliers, wherein the stopper has curved profile in cross section.

Preferably, about to the fishing pliers, wherein the upper clamping member is provided with the groove extending longitudinally, and the lower clamping member is provided with the tongue extending longitudinally.

Preferably, the fishing pliers, wherein the upper clamping member, the lower clamping member, the upper handle and the lower handle are made of plastic respectively, and the first and second gears are made by metallic material respectively.

the fishing pliers disclosed in the present invention, the first gear is fixed the front end of the upper clamping member and the second gear is fixed to the front end of the lower clamping member. The upper clamping member and the lower clamping member pivot to the front end of the upper handle through their respective gears, and the end of the lower clamping member connects to the front end of the lower handle. When the lower handle moves to the upper handle relatively, the first gear rotates with respect to the second gear correspondingly. Then contact or separation between the front end of the upper clamping member and the front end of the lower clamping member is realized, which leads to closing or opening for the jaw opening. Since the upper clamping member and the lower clamping member are all pivoted to the upper handle through their respective gears, the lower handle does not need to open in a large angle. In the case of using comfortably for the handles, the opening angle between the upper clamping member and the lower part is appropriate.

### BRIEF DESCRIPTION OF DRAWINGS

FIG. 1 (a) shows main view of a embodiment of the fishing pliers in which the jaw opening is fully opened

FIG. 1 (b) is left side view of the fishing pliers; FIG. 1 (c) is a sectional view taken along line C-C of FIG. 1(b);

FIG. 2 (a) shows main view of a embodiment of the fishing pliers in which the jaw opening is closed but is not locked; FIG. 2 (b) is left side view of the fishing pliers; FIG. 2 (c) is a sectional view taken along line B-B of FIG. 2 (b); and

FIG. 3 (a) shows main view of a embodiment of the fishing pliers in which the jaw opening is closed and is locked; FIG. 3 (b) is left side view of the fishing pliers; FIG. 3 (c) is a sectional view taken along line A-A of FIG. 2(b).

### DETAILED DESCRIPTION OF EMBODIMENTS

The present invention will be further described in detail with the figures so as to make technicians in the art can carry out the invention according to the Specification and the Claims.

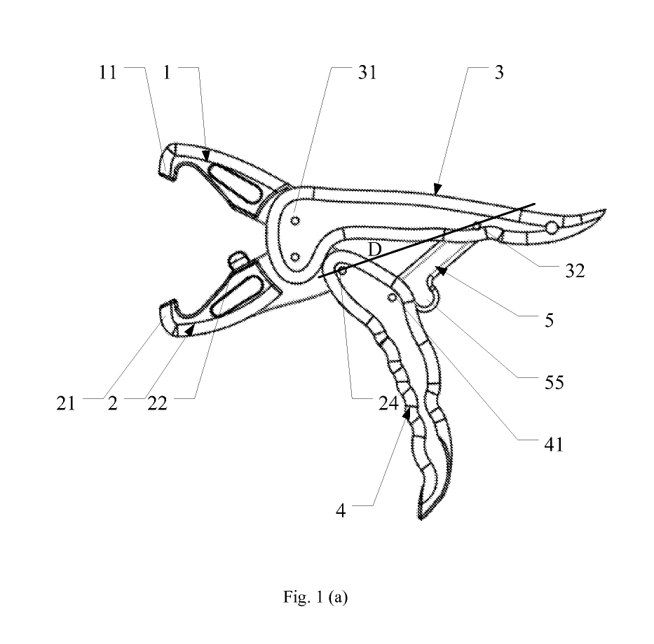

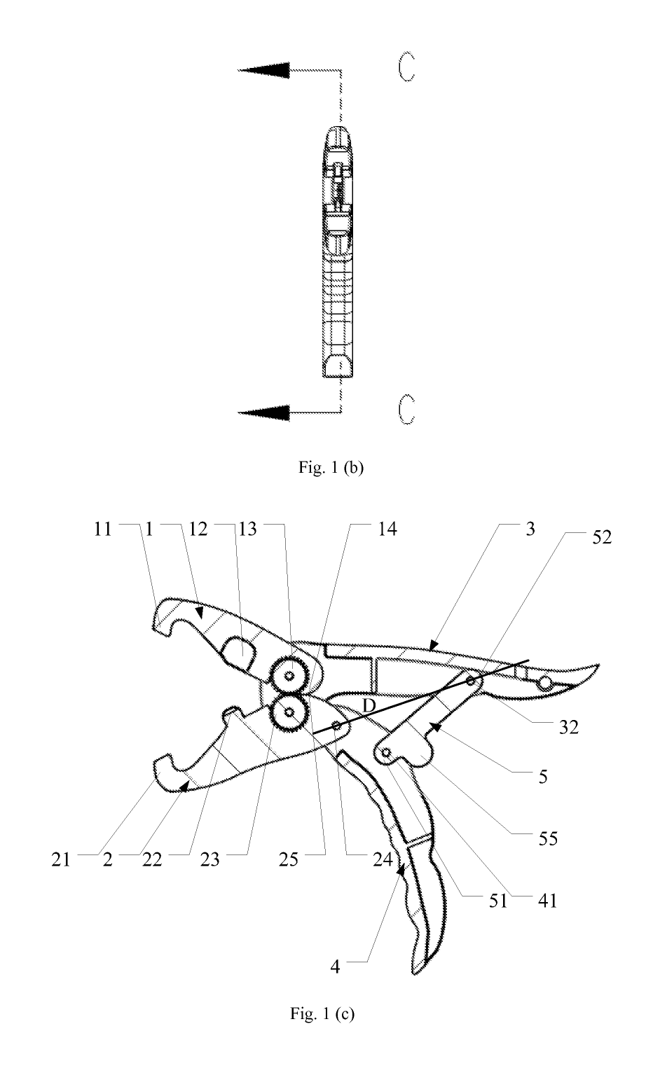

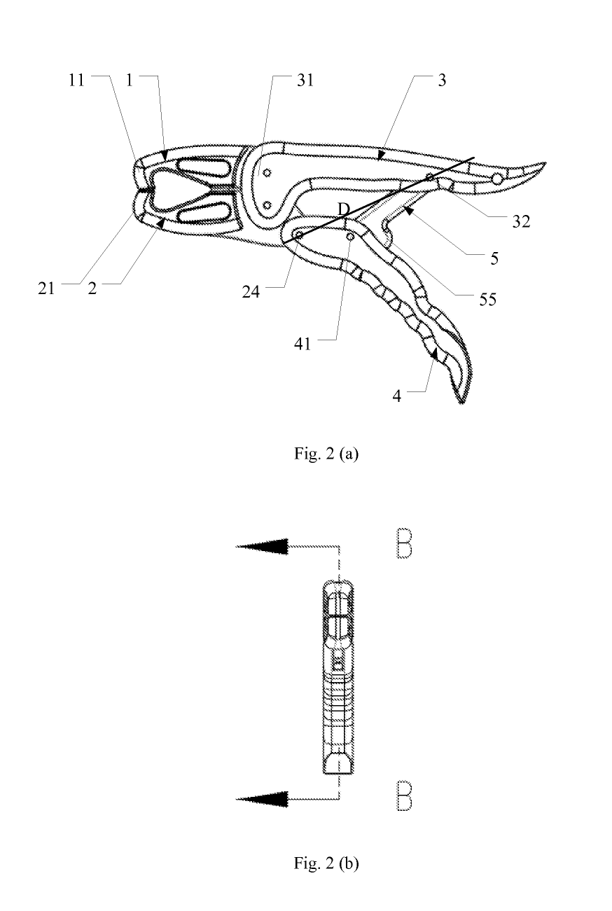

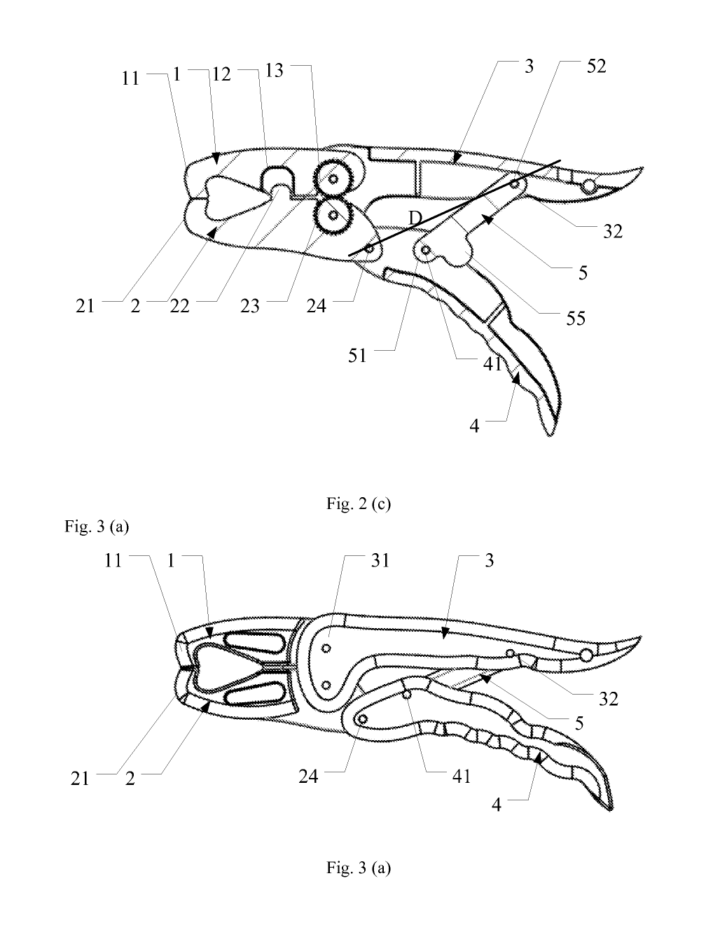

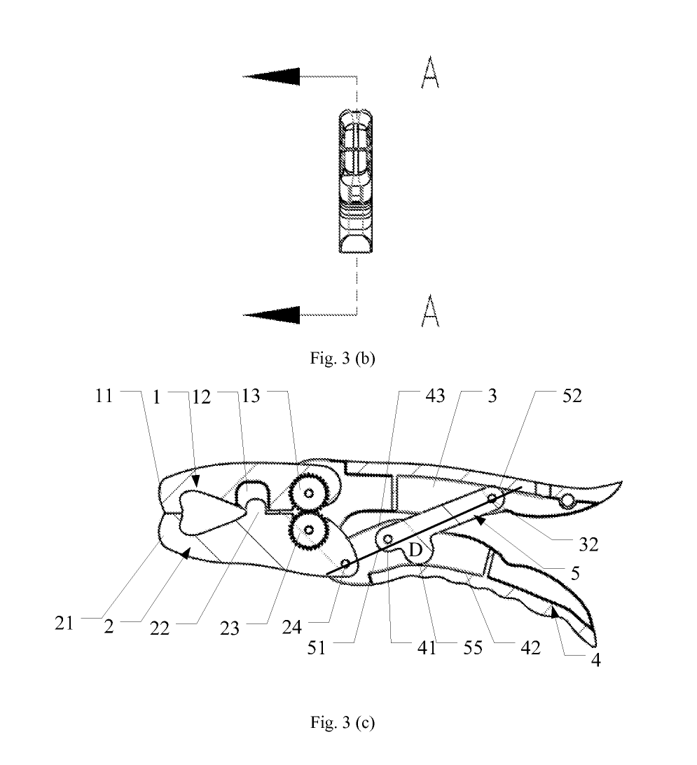

As shown in FIG. 1 (a), FIG. 1 (b), FIG. 1 (c), FIG. 2 (a), FIG. 2 (b), FIG. 2 (c), FIG. 3 (a), FIG. 3 (b) and FIG. 3 (c), the present invention provides a fishing pliers, includes a upper clamping member 1 of which front end 11 has a protrusion extending downwardly, and the upper clamping member also has a first gear 13 fixed after the front end. a lower clamping member 2 of which front end 21 has an protrusion extending upwardly. The protrusion extending upwardly and protrusion extending downwardly form a jaw opening for holding fish mouth together. A second gear 23 is fixed after the front end of the lower clamping member 2. The first gear 13 and the second gear 23 are engaged with each other. the upper clamping member 1 pivots to the front end 31 of an upper handle 3 by the drive shaft of the first gear 13, and the lower clamping member 2 pivots to the front end 31 of an upper handle 3 by the drive shaft of the second gear 23. The lower clamping member 2 pivots to the front end of a lower handle 4 by the first pivot point 24 of the back end of the lower clamping member. Wherein, with respect to the upper handle 3, moving the lower handle 4, the second gear of the lower clamping member 2 rotates with respect to the first gear of the upper clamping member relatively to implement contact or separation between the front end 11 of the upper clamping member and the front end 21 of the lower clamping member. Specifically, when operating the lower handle 4 to make the lower handle 4 move outwardly corresponding to the upper handle 3 (namely move in the direction away from the upper handle 3), the lower handle 4 will drive the lower clamping member 2 rotating outwardly around the first pivot joint 24. Then the second gear 23 rotates with the first gear 13 relatively which makes the front end 21 of the lower clamping member and the front end 11 of the upper clamping member separate with each other. In this case, the jaw opening will be opened. When operating the lower handle 4 to make the lower handle 4 move inwardly corresponding to the upper handle 3 (namely move in the direction close to the upper handle), the lower clamping member 2 will rotate inwardly around the first pivot joint 24. Then the second gear 23 rotates with the first gear 13 relatively which makes the front end 21 of the lower clamping member and the front end 11 of the upper clamping member contact with each other. In this case, the jaw opening will be closed to grip the fish mouths.

horizontally and a tongue and a groove cooperating with each other are provided on two relative laterals of the upper clamping member and the lower clamping member respectively, to make the tongue insert into the groove in the case of the front end of the upper clamping member and the front end of the lower clamping member contacting with each other. The so-called “horizontal” can be understood as the direction perpendicular to the paper.

In a preferred embodiment, in order to achieve locking of jaw opening, the fishing pliers further comprising: connecting rod 5, of which the first end 52 pivots to the second pivot point 32 on the upper handle 3, the second end 51 pivots to the lower handle 4 on the third pivot joint 41, and the pivoted position of the upper handle and the lower handle on is set as follows: When the lower handle 4 moves closely to the upper handle 3, the third pivot point 41 is located above the straight line D obtained through the connecting between the first pivot point 24 and the second pivot point 32. In this case, the front end of the upper clamping member 11 and the front end of the lower clamping member 21 are contacting with each other. In particular, as shown in the FIG. 1 (a) and FIG. 1 (c), when the jaw opening is fully opened, the third pivot joint 41 is located below the straight line D obtained by connecting the first pivot point 24 and the second pivot point 32 and is far away from the straight line D. As shown in FIG. 2 (a) and FIG. 2 (c), when the lower handle 4 moves closely to the upper handle 3 to make the jaw opening just close, the third pivot point 41 is still located below the straight line D, but closer to the straight line D. In this case, the lower handle 4 is still possible to automatically swing in the direction away from the upper handle 3, and cause the jaw opening open automatically. As shown in FIGS. 3 (a) and 3 (c), when the lower handle 4 moves closely to the upper handle, the third pivot point 41 moves above the straight line D. When the third pivot point 41 is located in a proper position, the lower handle 4 does not automatically swing, in the direction away from the upper handle 3. The jaw opening is locked and the front end 11 of the upper clamping member and the front end 21 of the lower clamping member will exert stable clamping force on the fish mouths. At this point, only appropriate force is exerted, the lower handle can be opened.

In a preferred embodiment, in order to prevent the lower handle passing over a suitable location when the lower handle moves closely to the upper handle, a limit structure is designed. A stopper (that is one kind of limit structures) 55 is formed on the connecting rod 5, which is protruded from the connecting rod 5 near the end of the lower handle. The protrusion length of the stopper is set as: When the lower handle 4 gradually moves closely to the upper handle 3, the third pivot point 41 moves from the space below the straight line D to the space above the straight line D obtained by connecting the first pivot point 41 and the second pivot point 32. When reaching a predetermined height, the stopper presses against the lower handle 4, so that the lower handle 4 cannot continue to move to close to the upper handle 3. Wherein the predetermined height is determined by when the front end of the upper clamping member and the lower clamping member contacts with each other, the contact force between the front end of the upper clamping member and the lower clamping member achieves a predetermined value. When achieving the predetermined value, the jaw opening is closed and locked, and the front end of the upper clamping member and the front end of the lower clamping member can provide sufficient clamping force to ensure the fish mouths is not easily sliding out of the fishing pliers.

In a preferred embodiment, in order to prevent the opening angle of the jaw opening being too large, another limited structure is provided. When the lower handle 4 moves far away from the upper handle 3 to make the front end of the upper clamping member and the front end of the lower clamping member is separating each other. A part 14 of the upper clamping member after the first gear interfering with A part 25 of the lower clamping member after the second gear. when the jaw opening opens to a certain extent, the part 14 of the upper clamping member after the first gear interferes with the part 25 of the lower clamping member 2 after the second gear to make the upper clamping member and the lower clamping member not continue to rotate in the direction away from each other. Wherein the opening angle of the jaw opening is considered as follows: the fish mouths can easily be placed in the jaw opening and the jaw can be quickly closed to clamp the fish lips.

In a preferred embodiment, a third pivot point 41 is located at a position close to the inner side 43 of the lower handle 4; the lower handle 4 has a hollow interior and the stopper 55 is inside the lower handle 4, and the stopper 55 presses against the lateral walls 42 of the lower handle.

In a preferred embodiment, in order to avoid bruising the fish and reducing the wears of the lower handle when pressing against the lower handle, the stopper of the fishing pliers has a curved profile on the cross section.

In a preferred embodiment, the upper clamping member 1 forms a longitudinally extending groove 12 and the lower holding part 2 forms a longitudinally extending tongue 23. Wherein, “longitudinally extending” refers extending within the paper from FIG. 1 (a) to FIG. 3 (c). The purpose of longitudinally extending is not to increase the width of the fishing pliers in the transverse direction.

In a preferred embodiment, in order to reduce the overall weight of the fishing pliers and to guarantee the fishing pliers not to sink to the bottom of the water, the upper clamping member 1, the lower clamping member 2, the upper handle 3 and the lower handle 4 of the fishing pliers are made of plastic. Meanwhile, in order to increase the strength of fishing pliers, to prolonging long life, the first gear and the second gear are made of metallic material.

Although the embodiments of the present invention has been disclosed above, it is not limited to the use of the manual and implementations listed, it can be applied in various fields suitable for the invention. For persons skilled in the art, it can be easily modified additionally, Therefore, under the general concept of the claims and equivalents without departing from the scope as defined, the present invention is not limited to the specific details and legends illustrated and described herein.

What is claimed is:

1. A fishing pliers comprising:
a upper clamping member having a protrusion extending downwardly at it's front end and a first gear fixed after the front end;
protrusion extending upwardly at it's front end to form a jaw opening for holding fish mouth with the protrusion extending downwardly positioned at the front end of the upper clamping member, and having a second gear fixed after the front end of the lower clamping member, which is engaged with the first gear;
an upper handle, the upper clamping member pivoting to the front end of the upper handle through the drive shaft of the first gear, and the lower clamping member pivoting to the front end of the upper handle through the drive shaft of the second gear and;
a lower handle, the lower clamping member pivoting to the front end of the lower handle at a first pivot point 24 of the back end of the lower clamping member;
Wherein, the lower handle moves with respect to the upper handle, to drive the second gear of the lower clamping member rotating with respect to the first gear of the upper champing member relatively, and to implement contact or separation between the front end of the upper clamping member and the front end of the lower clamping member.

2. Fishing pliers as described in claim 1, characterized by, a tongue and a groove cooperating with each other are provided on two relative laterals of the upper clamping member and the lower clamping member respectively, to make the tongue insert into the groove in the case of the front end of the upper clamping member and the front end of the lower clamping member contacting with each other.

3. Fishing pliers as described in claim 1, characterized by, further comprising:
connecting rod, whose first end pivoting to a second pivot point of the upper handle, and second end pivoting to a third pivot point of the lower handle, moreover, the pivoting position between the upper handle and the lower handle is configured to when the lower handle moves closely to the upper handle to make the front end of the upper clamping member and the front end of the lower clamping member contacting with each other, the third pivot point is located above a line obtained by connecting the first pivot and the second pivot.

4. Fishing pliers as described in claim 3, characterized by, the connecting rod having a stopper protruding outwardly at one end thereof near the lower handle, and the protruding length of the stopper is configured to: as the lower handle moves closely to the upper handle gradually, the third pivot point gradually moves from below to above a line obtained by connecting the first pivot and the second pivot, when reaching a predetermined height, the stopper contacting against the lower handle to make the lower handle avoid further closing to the upper handle;
wherein the predetermined height is determined by when the front end of the upper clamping member and the lower clamping member contacts with each other, the contact force between the front end of the upper clamping member and the lower clamping member achieves a predetermined value.

5. Fishing pliers as described in claim 4, characterized by, when the lower handle moves to a place far away from the upper handle to make the front end of the upper clamping member and the front end of the lower clamping member separate from each other, a part of the upper clamping member that is after the first gear interferes with a part of the lower clamping member that is after the second gear.

6. Fishing pliers as described in claim 4, characterized by, the third pivot point being located at a position closed to the inner side of the lower handle; the lower handle having a hollow interior space, and the stopper being located into the interior space and contacting against the outer lateral wall of the lower handle.

7. Fishing plier as claimed in claim 4, characterized by, the stopper having curved profile in cross section.

8. Fishing pliers as claimed in claim 2, characterized by, the upper clamping member provided with the groove extending longitudinally, and the lower clamping member provided with the tongue extending longitudinally.

9. Fishing pliers as claimed in claim 1, characterized by, the upper clamping member, the lower clamping member, the upper handle and the lower handle being made by plastic respectively, and the first and second gears being made by metallic material respectively.
